(19) United States
(12) Patent Application Publication
(10) Pub. No.: US 2003/0230244 A1
(43) Pub. Date: Dec. 18, 2003

(54) Pet bowl

(76) Inventor: Mark D. Morrison, New York, NY (US)

Correspondence Address: Peter W. Murphy, Hayes Soloway PC, 175 Canal Sreet, Manchester, NH, 03101, US

(21) Appl. No.: 10/271,642

(22) Filed: Oct. 15, 2002

Related U.S. Application Data
(63) Continuation-in-part of application No. 10/171,521, filed on Jun. 12, 2002, now abandoned.

(51) Int. Cl. A01K 1/10; A01K 5/00; A01K 39/00

(52) U.S. Cl. 119/61

(57) ABSTRACT

A pet bowl is disclosed that includes an inwardly directed lip portion to prevent accidental spillage of food or water.

### CROSS REFERENCE TO RELATED APPLICATION

This is a continuation in part of copending U.S. patent application Ser. No. 10/171,521 filed Jun. 12, 2002, the entire disclosure of which is incorporated herein by reference.

### FIELD OF THE INVENTION

The present invention relates to pet bowls and more particularly to a pet bowl with an inwardly directed lip portion to reduce spillage of food and water.

### BACKGROUND OF THE INVENTION

Pet bowls are known in the art. The bowls may be used to hold food or water. The bowls may be made from metal, plastic, or ceramic and may have a base dimension greater than a rim dimension. The bowls may be circular or rectangular. The shape of the inside portion of the bowl is concave and the inside dimension of the bowl typically increases from the base upward. The wall thickness of the bowls is typically uniform.

A drawback to these bowls is that the sloped inside surface of the bowl allows food or water in the bowl to easily spill out when the bowl is moved. What is needed is a pet bowl that includes an inwardly directed lip portion to impede water and food from spilling from the bowl.

### SUMMARY OF THE INVENTION

The invention is directed to a pet bowl that includes an inwardly directed lip portion to impede water and food from spilling from the bowl.

In one embodiment the invention provides a pet bowl having an interior volume for holding food or water. The interior volume defined by a bottom and an upwardly extending sidewall. The bowl further having a lip portion that extends inwardly from the surface of the sidewall. The lip portion having at least two downwardly extending portions that cooperate with the openings in the bowl to secure the lip portion to the bowl portion.

In another embodiment, the invention provides a lip for a pet bowl having an inwardly extending portion and a downwardly extending portion. The profile of the downwardly extending portion shaped to be captured in an opening on a cooperating bowl.

The above and other objects, feature, and advantages of the present invention will be apparent in the following detailed description thereof when read in conjunction with the appended drawings wherein the same reference numerals denote the same or similar parts throughout the several views.

### BRIEF DESCRIPTION OF THE DRAWINGS

FIG. 1 is a side view of a first exemplary pet bowl consistent with the present invention;

FIG. 2 is a side view of a second exemplary pet bowl consistent with the present invention;

FIG. 3 is a side view of a third exemplary pet bowl consistent with the present;

FIG. 4 is a side view of a fourth exemplary pet bowl consistent with the present invention; and

FIG. 5 is a side view of a fifth exemplary pet bowl consistent with the present invention.

### DETAILED DESCRIPTION OF THE INVENTION

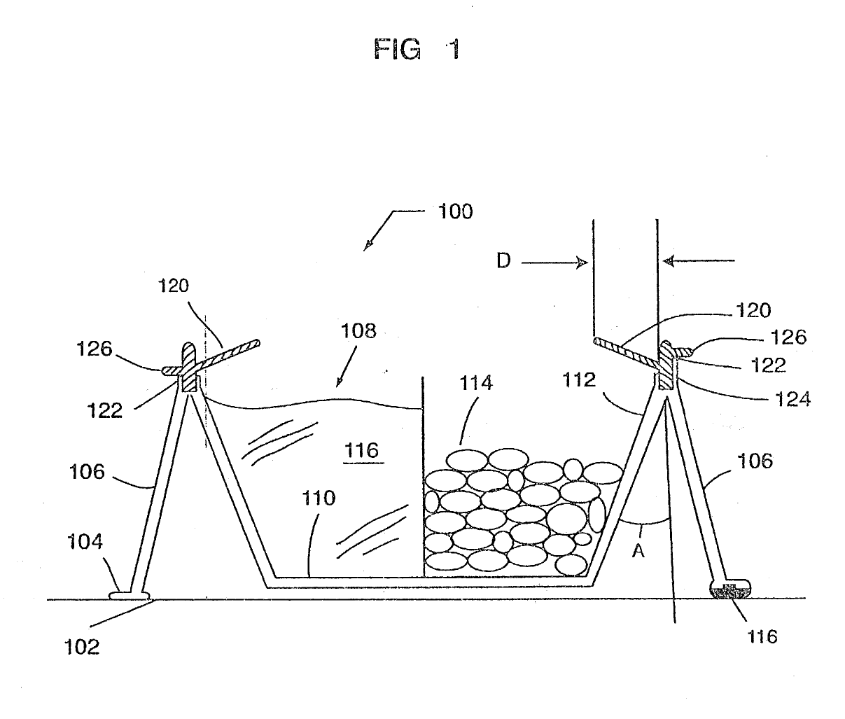

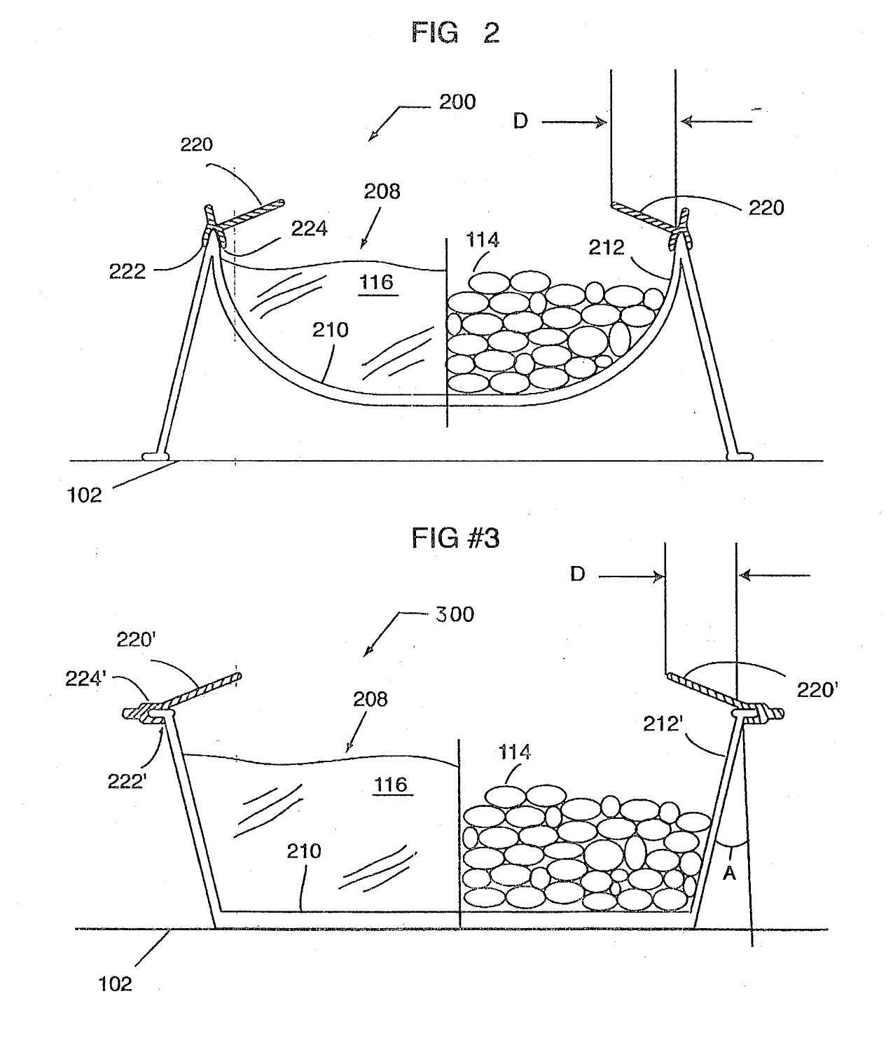

FIG. 1 shows a pet bowl 100 resting on a supporting surface 102. The bowl 100 has a bottom 110 and an upwardly extending sidewall 112 that form an interior volume 108. The bowl may be made from a polymeric, metallic, or ceramic material. The general shape of the bowl when viewed from the top may be circular, rectangular, oval, or any other shape. The interior volume 108 may alternately hold water 116 or food 114. The sidewall 112 may have a straight section that is oriented at an angle “A” to the vertical axis. Alternatively, the sidewall may have an arcuate shape (see FIG. 2). The sidewall 112 may be coupled to a downwardly extending leg portion 106. The leg portion 106 may have a foot portion 104 that extends outward. A non-slip pad 116 may be coupled to the foot to increase the sliding resistance of the bowl 100. The feet 104 may elevate the bowl so the bottom surface of the bottom 110 is not in contact with the supporting surface 102. The downwardly extending legs 106 may increase the outside dimension of the bowl 100 to make the bowl more stable.

A lip 120 may be coupled to the sidewall 112, the leg portion 106, or a web formed between the sidewall 112 and the leg portion 106 and extends inwardly a distance “D”. The distance “D” is measured from the inside surface of the sidewall at the upper end. The distance “D” is preferably 1/8″ to 1″, more preferably ⅜″ to ¾ and most preferably ½″. The lip 120 may be useful for preventing water or food from spilling out from the interior volume 108 when the bowl is moved. The lip 120 may extend around the entire perimeter of the bowl 100. The lip 120 may be secured in a recess 122 formed in the sidewall 112, the leg portion 106, or a web formed between the sidewall 112 and the leg portion 106. The lip 120 may be secured using a mechanical fit or an adhesive bond. Alternatively, the lip 120 may be releasably secured to the sidewall 112 to allow for separate washing or to allow for individual replacement. An upwardly standing rib 124 may be coupled to the leg portion 106 or a web formed between the sidewall 112 and the leg portion 106 to add structural support. The lip 120 may be made from a polymeric material, including but not limited to, neoprene, olefin, olefin rubber, PVC, isoprene, butyl rubber, butadiene rubber, and urethane. In profile, the inside surface of the lip 120 may be linear or arcuate. The lip 120 may also have an outwardly extending portion 126 which may be helpful in grasping and lifting the bowl 100 or inserting the lip 120.

Alternatively, the lip 120 may be integrally formed with the sidewall 112 and/or the leg portion 106 using a collapsible or fuseable core.

FIG. 2 shows a pet bowl 200 having a bottom 210 and a sidewall 212 that form an interior volume 208 for holding water 116 or food 114. A lip 220 having downwardly projecting tabs 222 and 224 may contact the inside and outside surface of the sidewall 212. A portion of the sidewall 212 may be sandwiched in between the tabs 222 and 224. The tabs 222 and 224 do not have to extend around the entire perimeter of the sidewall 212.

FIG. 3 shows a bowl 300 having a lip 220′ having a pair of inwardly directed tabs 222′ and 224′ that cooperate with a horizontal portion of the sidewall 212′. The lip 220 and 220′ may be made in a loop or in strips.

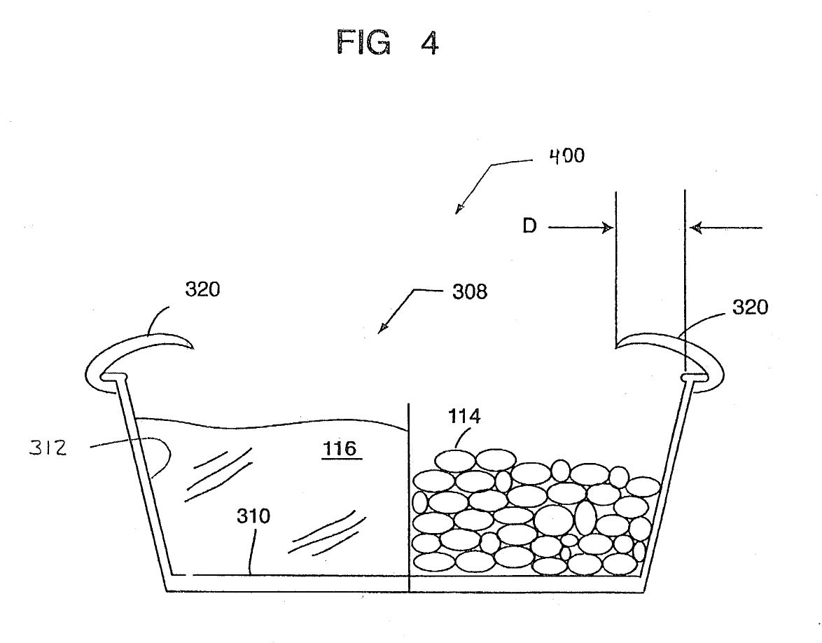

Alternatively, as shown in FIG. 4, a lip 320 may be compressively coupled to the outside surface of sidewall 312 of a bowl 400. The lip 320 may be formed in a loop with the dimension of the loop being smaller than the outside dimension of the bowl. To compressively couple the lip 320 to the bowl 400, the user stretches the loop around the outside of the bowl 400 and then releases, thereby applying a compressive force to the outside surface of the bowl.

The lip 220, 220′, and 320 may be sold separately from a bowl to allow a user to add a lip to an existing bowl. The lip material may have elastic characteristics that allow the lip to fit a variety of differently sized and shaped bowls.

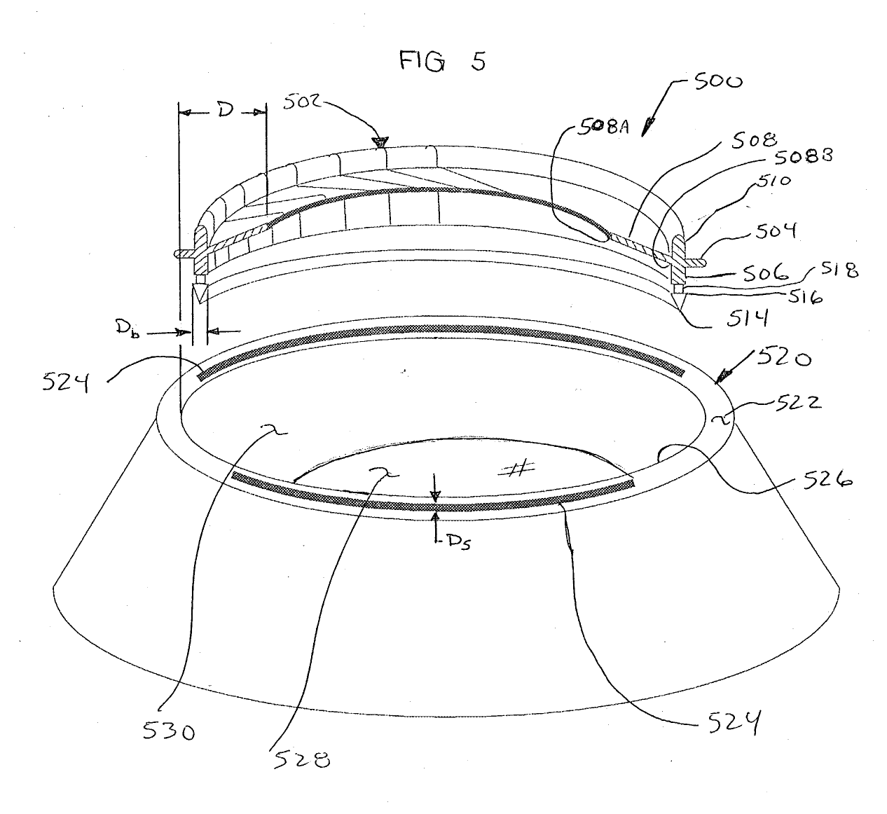

FIG. 5 shows a fifth embodiment pet bowl assembly 500 having a bowl portion 520 and a lip portion 502. The bowl may have a bottom surface 528 and a side surface 530. The bowl portion may also have a surface 522, preferably a horizontal surface at the top of the sidewall 530. The surface 522 has an opening 524, preferably two or more openings 524, along the perimeter. The opening 524 preferably extends through the surface 522 and has a width “D_{S}”. The openings are shown as elongated slots, but other shapes including circles are contemplated.

The lip portion 502 may have an outwardly extending portion 504, a downwardly extending portion 506, an inwardly extending portion 508, and upwardly standing portion 510. The inside edge 508A of the inwardly extending lip 508 is preferably elevated relative to the base 508B. Alternatively, the inside edge 508A may be level with or below the base 508B. When coupled to the bowl portion 520, the inwardly extending portion 508 extends inward a distance “D”. The distance “D” is measured from the inside surface of the sidewall at the upper end. The distance “D” is preferably ⅛″ to 1″, more preferably ⅜″ to ¾ and most preferably ½″. The lip portion 502 may be useful for preventing water or food from spilling when the bowl is moved. The inwardly extending lip portion 508 may extend continuously around the entire perimeter of the bowl 502 and the downwardly extending portion 506 may extend discontinuously around the perimeter of the bowl 502. In a preferred embodiment, the lip portion includes the inwardly extending portion 508 and the downwardly extending portion 506.

The downwardly extending portion 506 preferably has a profile that is narrower at a tip 514 than at a base 516. The preferred profile is generally shaped like an arrowhead. The profile of the downwardly extending portion may also include a section 518, located above the base 516, which is narrower than the width “D_{b}” of base 516.

The dimension “D_{b}” is preferably sized slightly greater than the dimension “D_{S}” of opening 524. The profile and size of the downwardly extending portion 506 and the dimension of the opening 524 may depend on the types of materials used. In an alternative embodiment, the downwardly extending portions include a plurality of individually spaced protrusions that may be inserted through individual holes in the surface 522 of the bowl.

In an alternative embodiment, the openings are formed in the sidewall 530 of the bowl and the lip includes an inwardly extending portion and an outwardly extending portion. The outwardly extending portion cooperating with the openings formed in the sidewall of the bowl.

In an alternative embodiment, the bowl may be used as a litter box to hold pet litter, preferably cat litter.

It should be understood that various features and options disclosed may be combined and are within the scope of the present invention. The bowl of the present invention may be used as a human bowl.

It should be understood that, while the present invention has been described in detail herein, the invention can be embodied otherwise without departing from the principles thereof, and such other embodiments are meant to come within the scope of the present invention as defined in the following claims:

I claim:

1. A pet bowl assembly, comprising:
a bowl portion having an interior volume defined by a bottom, an upwardly extending sidewall, and a generally horizontal top surface having at least one opening extending there through; and
a lip portion extending inwardly of an inside surface of the upwardly extending sidewall, the lip portion having at least one downwardly extending portion that cooperates with the opening to secure the lip portion to the bowl portion.

2. The pet bowl of claim 1, wherein the bowl portion comprises one of a polymeric and a metallic material.

3. The pet bowl of claim 1, wherein the lip portion extends at least ½″ inward of the interior surface of the sidewall.

4. The pet bowl of claim 1, wherein the lip portion comprises a material that is different from the material comprising the bowl portion.

5. The pet bowl of claim 1, wherein the downwardly extending portion has a width greater than a width of the opening.

6. The pet bowl of claim 1, wherein the lip portion further comprising an outwardly extending portion.

7. The pet bowl of claim 1, wherein the lip portion extends around the perimeter of the sidewall.

8. The lip of claim 1, wherein the lip portion comprises one of a neoprene and a butyl rubber.

9. The lip of claim 1, wherein the downwardly extending portion has an arrow-head profile.

10. A lip for a pet bowl, comprising:
an inwardly directed portion; and
a downwardly extending portion for securing the lip to the pet bowl through a plurality of openings disposed about the perimeter of the pet bowl, the downwardly extending portion having a distal end having a first width narrower than a width of the opening and a portion spaced from the distal end having a second width greater than the width of the opening.

11. The lip of claim 10, wherein the lip extends at least ½″ inward of the downwardly extending portion.

12. The lip of claim 10, wherein the lip further comprising an outwardly extending portion.

13. The lip of claim 10, wherein the lip forms a closed loop.

14. The lip of claim 10, wherein the lip comprises one of a neoprene and a butyl rubber.

15. A pet bowl assembly, comprising:
a bowl portion having an interior volume defined by a bottom and an upwardly extending sidewall, the sidewall having two or more through openings; and
a lip portion extending inwardly of an inside surface of the upwardly extending sidewall, the lip portion having two or more outwardly extending portions that cooperate with the openings in the sidewall to secure the lip portion to the bowl portion.

16. A lip for a pet bowl, comprising:
an inwardly directed portion; and
a outwardly extending portion for securing the lip to the pet bowl through a plurality of openings disposed about a sidewall of the pet bowl, the outwardly extending portion having a distal end having a first width narrower than a width of the openings and a portion spaced from the distal end having a second width greater than the width of the opening.

17. A pet bowl, comprising:
an interior volume defined by a bottom and an upwardly extending sidewall; and
a lip portion extending inwardly of an interior surface of the sidewall.

18. The pet bowl of claim 17, further comprising a downwardly extending leg portion coupled to the upwardly extending sidewall.

19. The pet bowl of claim 18, further comprising a non-slip contact region at a distal end of the downwardly extending leg portion.

20. The pet bowl of claim 17, wherein the bottom and the sidewall comprise one of a polymeric material and a metallic material.

21. The pet bowl of claim 17, wherein the lip extends at least ½″ inward of the interior surface of the sidewall.

22. The pet bowl of claim 17, wherein the lip portion comprises a material that is different from the material comprising the sidewall.

23. The pet bowl of claim 17, wherein the sidewall comprises a recess for securing the lip portion to the sidewall.

24. The pet bowl of claim 17, further comprising a downwardly extending leg portion coupled to the upwardly extending sidewall by an intermediate region.

25. The pet bowl of claim 24, wherein the intermediate region comprises a recess for securing the lip portion.

26. The pet bowl of claim 17, wherein the lip portion extends around the perimeter of the sidewall.

27. A lip for a pet bowl, comprising:
an inwardly directed portion; and
a gripping portion for securing the lip about the perimeter of the pet bowl.

28. The lip of claim 27, wherein the lip is releasably securable to an outwardly directed lip about the perimeter of the bowl.

29. The lip of claim 27, further comprising a pair of downwardly projecting tabs that securable couple the lip to the bowl.

30. The lip of claim 27, wherein the lip is compressively coupled to an outside surface of the bowl.

31. A lip for a pet bowl, comprising:
an elastic polymeric material formed in a loop and having a first portion for contacting the outside surface of the bowl and an inwardly directed second portion.

32. The lip of claim 31, wherein the lip is compressively coupled to the bowl.

33. The lip of claim 31, wherein the material is neoprene.

34. The lip of claim 31, wherein the material is butyl rubber
